(19) United States
(12) Patent Application Publication
(10) Pub. No.: US 2002/0093159 A1
(43) Pub. Date: Jul. 18, 2002

(54) Juvenile stroller with cooler

(76) Inventors: Dennis M. Turner, Mooresville, IN (US); Andrew Mendenhall, Indianapolis, IN (US); Paul T. Zink, Anderson, IN (US)

Correspondence Address: BARNES & THORNBURG, 11 SOUTH MERIDIAN, INDIANAPOLIS, IN, 46204

(21) Appl. No.: 10/044,668

(22) Filed: Jan. 11, 2002

Related U.S. Application Data
(60) Provisional application No. 60/261,605, filed on Jan. 12, 2001.

(51) Int. Cl. B62B 11/00

(52) U.S. Cl. 280/47.35; 280/47.38

(57) ABSTRACT

A stroller includes a frame, a seat coupled to the frame, wheels coupled to the frame, and a container including a thermally insulated storage region. In one embodiment, at least a portion of the container is situated below the seat. The container is coupled to the frame. The container provides an internal storage region and includes side walls. At least one of the side walls including an access panel movable between an orientation to permit access to the storage region and an orientation to restrict access to the storage region. In another embodiment, the container is movable between a first orientation attached to the stroller and a second orientation detached from the stroller. The container is oriented in an opening provided by the frame when the container is in the first orientation.

This application claims priority under 35 U.S.C. 119(e) to U.S. Provisional Application Serial No. 60/261,605, filed Jan. 12, 2001, which is expressly incorporated by reference herein.

### BACKGROUND AND SUMMARY

The present disclosure relates to juvenile strollers, and particularly to stroller accessories. More particularly, the present disclosure relates to storage units adapted to be carried onboard juvenile strollers.

Juvenile strollers are being adapted to carry various child-care items in handy onboard locations in addition to carrying infants or other young children. Caregivers appreciate the convenience of being able to store child-care items or other items needed by caregivers or siblings onboard strollers. In this way, those items will be handy to the caregiver when the stroller is being used to transport a child.

According to one aspect of the disclosure, a stroller comprises a frame, a seat and wheels coupled to the frame, and a thermally insulated container coupled to the frame. The container includes side walls and provides an internal storage region. At least a portion of the container is situated below the seat. At least one of the side walls includes an access panel that moves between an orientation permitting access to the storage region and an orientation restricting access to the storage region.

According to another aspect of the disclosure, the stroller frame includes spaced-apart front and rear legs. An opening is defined between the front and rear legs. The container includes a thermally insulated storage region and is movable between a first orientation attached to the stroller and a second orientation detached from the stroller. The container is slidable into the opening when a user moves the container to the first orientation and from the opening when a user moves the container to the second orientation.

According to a further aspect of the disclosure, the stroller also comprises a seat, wheels, and a basket coupled to the frame. The container is positioned to lie between the front legs of the stroller and the rear legs of the stroller when the container is in the first orientation.

Additional features of the disclosure will become apparent to those skilled in the art upon consideration of the following detailed description of preferred embodiments exemplifying the best mode of carrying out the disclosure as presently perceived.

### BRIEF DESCRIPTION OF THE DRAWINGS

The detailed description particularly refers to the accompanying figures in which:

FIG. 1 is a fragmentary perspective view of a juvenile stroller in accordance with the disclosure showing a seat frame, and a storage basket positioned to lie below a seat coupled to the seat frame, the basket including a thermally insulated storage region configured to store items;

FIG. 2 is a perspective view of a rear portion of the stroller of FIG. 1 showing a side door opened to expose the storage region in the basket;

FIG. 3 is a perspective view of another embodiment of a juvenile stroller, having a compartment with a side opening, and a thermally insulated container in the compartment, the container having a flip-out panel opened to reveal a storage region in the container;

FIG. 4 is a perspective view of the juvenile stroller of FIG. 3 showing the container removed from the compartment in the basket, a lid in an opened position to reveal the storage region, and a carrying strap coupled to the container;

FIG. 5 is a fragmentary perspective view of a juvenile stroller similar the stroller shown in FIG. 3, showing a modified basket coupled to the stroller frame defining a space between a front wall of the basket and a front of the stroller frame, and a container situated in the space and attached to the stroller; and

FIG. 6 is a fragmentary perspective view of the stroller of FIG. 5, showing the thermally insulated container detached from the stroller, the space between the container and the front of the stroller, an opened flip-out panel of the container exposing a storage region, and a carrying strap attached to the container.

### DETAILED DESCRIPTION OF THE DRAWINGS

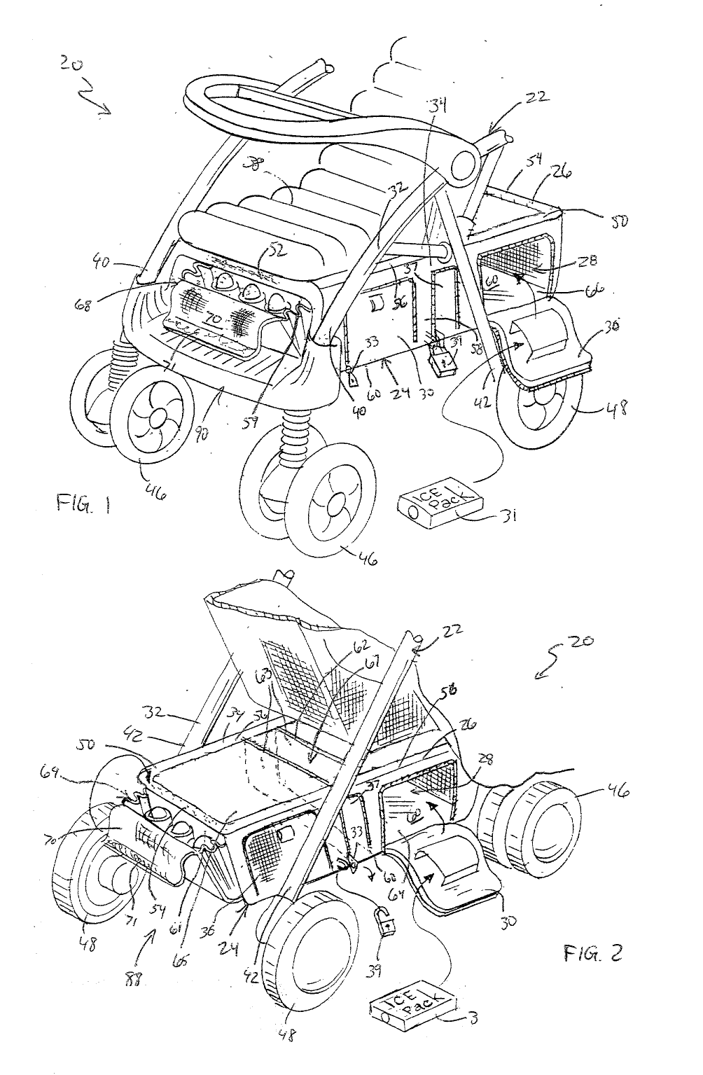

Referring now particularly to FIGS. 1 and 2, a juvenile stroller 20 includes a stroller frame 22 and a thermally insulated storage basket 24 configured to store items. The thermally insulated storage basket 24 is coupled to the stroller frame 22 to move therewith as the stroller 20 is pushed. Thermally insulated storage basket 24 includes a basket body 26 formed to include an interior storage region 28 therein.

Stroller frame 22 includes a seat frame 32, and a basket support frame 34 coupled to seat frame 32. Basket 24 is coupled to basket support frame 34. A seat 38 is coupled to seat frame 32 in any suitable manner. It is within the scope of this disclosure to employ a wide variety of seats and seat frames. In the illustrated embodiment, seat frame 32 includes a pair of front legs 40, a pair of rear legs 42, and a push handle (not shown). Front wheels 46 are coupled to each front leg 40 and rear wheels 48 are coupled to each of rear legs 42.

Front and rear panels or doors 30, 36 are coupled to basket body 26 for movement between respective closed positions closing interior storage region 28 and opened positions permitting access to interior storage region 28. Basket body 26 and doors 30, 36 cooperate to provide a thermally insulated case in which child-care or other items can be placed to be maintained in a temperature controlled environment.

This thermally insulated case is adapted to receive an ice pack 31, a heat pack (not shown), or any other suitable heat source or sink to provide some control over the temperature in interior storage region 28. Storage basket 24 functions as a thermally insulated storage region to provide some control of the temperature of articles stored therein relative to an ambient temperature outside the storage region for a period of time so that cold articles stored in the thermally insulated storage region will be insulated against heat gain and warm articles stored in the thermally insulated storage region will be insulated against heat loss.

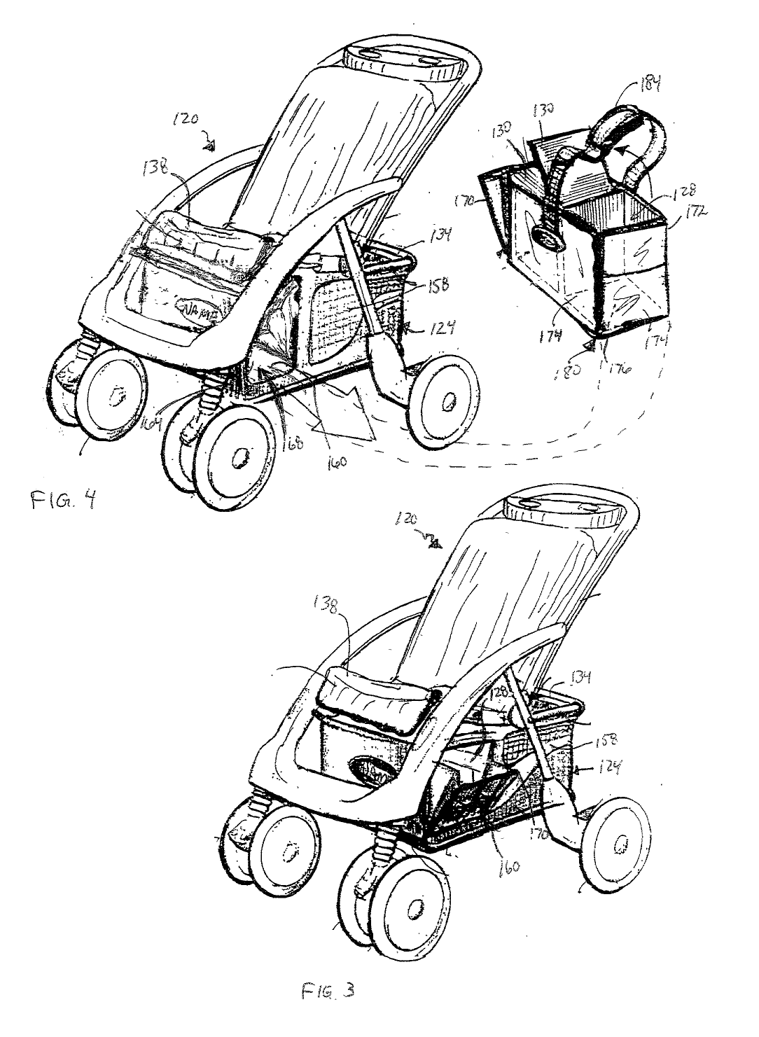

Basket support frame 34 has an upper rim 50 including front and rear sections 52, 54 and side sections 56 extending between the front and rear sections 52, 54. Basket 24 can be coupled to basket support frame 34 in any suitable manner. It is within the scope of this disclosure to form basket support frame 34 and basket 24 as a single component as shown in FIGS. 1 and 2, or as separate components, as shown in FIGS. 3 and 4 by using, for example, a tubular member for support frame 134 and suspending basket 124 therefrom. Basket support frame 34 and basket 24 cooperate to form a storage container, which storage container can be mounted in any suitable location on stroller frame 22. As shown in FIGS. 1 and 2, basket support frame 34 is coupled to seat frame 32 so that a front portion of basket 24 lies generally under seat 38.

As shown in FIGS. 1 and 2, basket 24 includes side walls 58, front wall 59, and rear wall 61, each extending downwardly from rim 50 and joining a bottom 60, to support articles that a user places in basket 24. A top 65 is coupled to rim 50 to close basket 24. A divider 62 extends between side walls 58 from bottom 60 to top 65 to provide a front compartment 64 adjacent a front 90 of stroller 20 and a rear compartment 66 adjacent a rear 88 of stroller 20. As shown in FIG. 2, divider 62 includes a pair of spaced apart interior walls 63 extending between side walls 58 and between bottom 60 and top 65 to form a middle compartment 67.

Front, middle, and rear doors 30, 37 and 36 are provided in each of side walls 58 to permit access to front compartment 64, middle compartment 67, and rear compartment 66 from either side of the stroller 20. Illustratively, side walls 58 are made of a flexible material, such as layers of pliable woven material or resin sheet with layers of thermal insulation sandwiched between them, and front, middle, and rear doors 30, 37 and 36 are flaps cut in the material of side walls 58, with zippers 33 to maintain the doors 30, 37 and 36 in closed positions. It is within the scope of this disclosure, however, to use any suitable material for front, middle, and rear doors 30, 37 and 36 and side walls 58. It is also within the scope of this disclosure to provide front, middle, and rear doors 30, 37 and 36 as separate components, and to couple the doors to basket 24 in any suitable fashion to permit movement of the doors to close and open front, middle, and rear compartments 64, 67 and 66 to provide access into interior storage region 28. Illustratively, locks 39 are provided on doors 37, so that a user can store valuables in middle compartment 67.

Basket 24 further includes a front receptacle 68 coupled to front wall 59 and a rear receptacle 69 coupled to rear wall 61. A flap 70 provided on each receptacle 68, 69 selectively closes the receptacle 68, 69. Each of receptacles 68, 69 includes a closure 71, illustratively constructed of synthetic hook-and-loop fastener material, to secure flaps 70 to upper rim 50. However, it is within the scope of this disclosure to provide any suitable closure 71, such as snaps, buttons and button holes, zippers, straps, clips, ties, or other suitable fasteners.

Referring again to FIGS. 3 and 4, a second embodiment of a stroller 120 includes a basket 124 and a separate, removable, thermally insulated container 180 including a bottom 176, and side walls 174 extending upward from bottom 176 to form a storage region 128. Lids 130 are provided to close the top of thermally insulated container 180 with zippers, snaps, or other suitable fasteners. Lids 130 can be hinged or otherwise attached to thermally insulated container 180 to permit storage region 128 to be opened and closed at the option of the user. It is within the scope of this disclosure to provide lids 130 and container 180 as a single component, for example, a molded resin component, with (a) flexible hinge(s) permitting the lids 130 to be moved between the opened and closed positions.

Thermally insulated container 180 is slidably received in a front compartment 164 of basket 124 through an opening 168 in one of side walls 158. When container 180 is placed in front compartment 164, container 180 is below seat 138 and container bottom 176 is supported by basket bottom 160.

Container 180 includes a side access panel 170 movable between a position permitting access to storage region 128 and a position restricting access to the storage region 128. As best illustrated in FIG. 3, when container 180 is stowed in compartment 164, storage region 128 is accessible through side access panel 170 without removing container 180 from compartment 164.

As illustrated in FIG. 4, a carrying strap 184 is provided to facilitate transport of thermally insulated container 180 away from stroller 120. Carrying strap 184 can be coupled to container 180 in any suitable manner, for example, by sewing the ends of the strap 184 to opposite side walls 174 of container 180. Carrying strap 184 can also be removably coupled to container 180 in a variety of ways, for example, by providing snaps, buttons and holes, hook-and-loop fasteners, clips, ties, or other suitable fasteners. Another example showing a strap 184 removably coupled to container 180 is disclosed in U.S. patent application Ser. No. 09/938,951 of Andrew Mendenhall, entitled, “JUVENILE STROLLER WITH COOLER,” filed Aug. 24, 2001, the disclosure of which is hereby incorporated by reference herein.

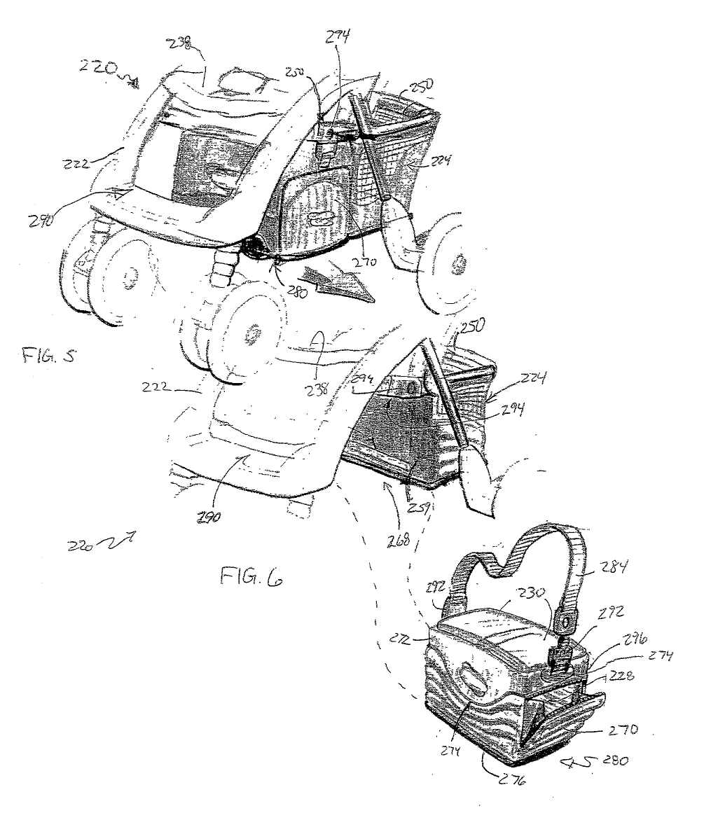

Referring now to FIGS. 5 and 6, a third embodiment of a stroller 220 includes a basket 224 and a removable thermally insulated container 280 including a bottom 276 and side walls 274 coupled to and extending upward from bottom 276 to form storage region 228. Lids 230 may be hinged or otherwise attached to thermally insulated container 280 by zippers, snaps, or other suitable fasteners, to permit access to storage region 228 at the option of the user. Again, it is within the scope of this disclosure to provide lids 230 and container 280 as a single component, for example, a molded resin component, with (a) flexible hinge(s) permitting the lids 230 to be moved between the opened and closed positions.

Thermally insulated container 280 can be stored in a space 268 between a front wall 259 of basket 224 and the front 290 of stroller 220. Container 280 includes first retainer portions 292 of squeeze-to-release clips. Complementary second portions 294 of squeeze-to-release clips are mounted on each side of stroller 220 above and adjacent space 268 for coupling container 280 to stroller 220. Additionally, a carry strap 284 is provided with these complementary second portions 294, so that when the container 280 is released from stroller 220, carry strap 284 can be coupled to the container 280 to facilitate transport of container 280. It is within the scope of this disclosure to include any combination of cooperating retainer portions to releasably couple container 280 to stroller 220, including, for example, posts or hooks and cooperating eyes, snaps, buttons and cooperating holes, synthetic hook and loop fasteners, and the like. Additionally, it is within the scope of this disclosure to include other means of supporting container 280 in space 268, including, for example, a shelf or other engagement surface provided on basket 224, stroller frame 222, or seat 238.

When container 280 is situated in space 268, it is positioned below seat 238 and adjacent basket front wall 259. Container 280 includes a side access panel 270 movable between a position permitting access to storage region 228 and a position closing storage region 228. As shown in FIG. 5, when container 280 is in space 268, storage region 228 is accessible through side access panel 270 without removal of container 280 from space 268.

Although the disclosure has been described in detail with reference to certain preferred or illustrative embodiments, variations and modifications exist within the scope and spirit of the disclosure as described and defined in the following claims.

1. A stroller comprising
a frame,
a seat coupled to the frame,
a plurality of wheels coupled to the frame, and
a thermally insulated container coupled to the frame, the container providing an internal storage region and including side walls, at least a portion of the container situated below the seat, and at least one of the side walls including an access panel movable between an orientation to permit access to the storage region and an orientation to restrict access to the storage region.

2. The stroller of claim 1, wherein the thermally insulated container includes a basket secured to the frame.

3. The stroller of claim 1, further comprising a receptacle for holding articles, the receptacle coupled to a side wall of the container, the receptacle including a flap movable between an orientation to permit access to the receptacle and an orientation closing the receptacle, and a closure to maintain the flap in the closed orientation.

4. The stroller of claim 1, wherein the container further includes a second access panel coupled to a side wall, the second access panel movable between an orientation to permit access to the storage region and an orientation to restrict access to the storage region.

5. The stroller of claim 1, wherein the container further includes a divider to divide the storage region into a first storage compartment and a second storage compartment.

6. The stroller of claim 5, wherein the container further includes a second access panel coupled to one of the side walls, the first access panel being movable between an orientation to permit access to the first storage compartment and an orientation to restrict access to the first storage compartment, and the second access panel being movable between an orientation to permit access to the second storage compartment and an orientation to restrict access to the second storage compartment.

7. The stroller of claim 6, wherein the divider includes a pair of spaced apart walls forming a third storage compartment, and the container further includes a third access panel movable between an orientation to permit access to the third storage compartment and an orientation to restrict access to the third storage compartment.

8. A stroller comprising
a frame including spaced apart front and rear legs defining an opening between the front and rear legs,
a seat coupled to the frame,
wheels coupled to the frame, and
a container coupled to the frame, the container including a thermally insulated storage region and being movable between a first orientation attached to the stroller and a second orientation detached from the stroller, the container being slidable into the opening when a user moves the container to the first orientation and from the opening when a user moves the container to the second orientation.

9. The stroller of claim 8, wherein the container includes at least one side wall, an access panel coupled to the side wall and movable between an orientation to permit access to the storage region and an orientation to restrict access to the storage region.

10. The stroller of claim 8, further comprising a basket including a front basket wall generally facing a front of the stroller but spaced from the front of the stroller, the opening being defined at least in part by the front basket wall.

11. The stroller of claim 10, wherein the container includes a first retainer portion and the stroller further includes a second retainer portion to cooperate with the first retainer portion to attach the container in the first orientation.

12. The apparatus of claim 11, further comprising a carrying strap including a second retainer portion, the strap being attachable to the first retainer portion when the first retainer portion is detached from the second retainer portion of the stroller to facilitate transport of the container when the container is detached from the second retainer portion of the stroller.

13. The stroller of claim 10, wherein the basket has a bottom, the opening is defined at least in part by the bottom, and the bottom supports the container when the container is in the first position.

14. The stroller of claim 10, wherein the basket further includes a rear portion having a second opening between the rear legs of the stroller.

15. A stroller comprising
a frame including front and rear legs spaced apart to define an opening between them,
a seat coupled to the frame,
wheels coupled to the frame,
a basket coupled to the frame, and
a thermally insulated container movable between a first orientation attached to the stroller and a second orientation detached from the stroller, the container being oriented in the opening when the container is in the first orientation, the container being situated between the front legs of the stroller and the rear legs of the stroller when the container is in the first orientation, the container providing a thermally insulated storage region.

16. The stroller of claim 15, wherein the container includes a carrying strap facilitating transport of the container when it is not in the first orientation.

17. The stroller of claim 15, wherein the container includes a lid for movement between a position restricting access to the storage region and a position providing access to the storage region.

18. The stroller of claim 17, wherein the container further includes a dividing wall dividing the storage region into a first compartment and a second compartment, a second lid for movement between a position restricting access to the storage region and a position providing access to the storage region, the first compartment accessible through the first-mentioned lid and the second compartment accessible through the second lid.

19. The stroller of claim 15, wherein the basket includes a front wall and a bottom, the front wall generally lying adjacent the front of the stroller, the bottom terminating adjacent the front wall, the container being supported by the bottom when the container is in the first orientation.

20. The stroller of claim 15, wherein the basket includes a front wall generally facing a front of the stroller but spaced from the front of the stroller, the container being positioned between the front legs and the front wall when the container is in the first orientation.
